(19) United States
(12) Patent Application Publication
(10) Pub. No.: US 2022/0131191 A1
(43) Pub. Date: Apr. 28, 2022

(54) ELECTROLYTE SOLUTION FOR LITHIUM SECONDARY BATTERY AND LITHIUM SECONDARY BATTERY INCLUDING THE SAME

(71) Applicants: HYUNDAI MOTOR COMPANY, Seoul (KR); Kia Corporation, Seoul (KR); The Industry & Academic Cooperation in Chungnam National University (IAC), Daejeon (KR)

(72) Inventors: Yoon Ji Lee, Bucheon-si (KR); Yoon Sung Lee, Suwon-si (KR); Seung Ho Ahn, Hanam-si (KR); Seung Wan Song, Sejong-si (KR)

(73) Assignees: HYUNDAI MOTOR COMPANY, Seoul (KR); Kia Corporation, Seoul (KR); The Industry & Academic Cooperation in Chungnam National University (IAC), Daejeon (KR)

(21) Appl. No.: 17/399,251

(22) Filed: Aug. 11, 2021

(30) Foreign Application Priority Data
Oct. 28, 2020 (KR) 10-2020-0141278

(51) Int. Cl. H01M 10/0567; H01M 10/0568; H01M 10/0569; H01M 10/0525; H01M 4/525; H01M 4/505; H01M 4/38; H01M 4/587

(52) U.S. Cl. CPC H01M 10/0567; H01M 10/0568; H01M 10/0569; H01M 10/0525; H01M 2300/0025; H01M 4/505; H01M 4/386; H01M 4/587; H01M 4/525

(57) ABSTRACT

The electrolyte solution for a lithium secondary battery includes: a lithium salt, a solvent, and a functional additive, wherein the functional additive contains a bis(2,2,2-trifluoroethyl) carbonate, expressed by Formula 1 below:

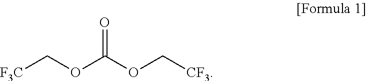 [SMILES: O=C(OCC(F)(F)F)OCC(F)(F)F]

### CROSS REFERENCE TO RELATED APPLICATION

The present application claims priority to and the benefit of Korean Patent Application No. 10-2020-0141278, filed on Oct. 28, 2020, the entire contents of which are incorporated herein by reference.

### FIELD

The present disclosure relates to an electrolyte solution for a lithium secondary battery and a lithium secondary battery including the same.

### BACKGROUND

The statements in this section merely provide background information related to the present disclosure and may not constitute prior art.

A lithium secondary battery is an energy storage device composed of a cathode providing lithium and an anode receiving the lithium during charging, an electrolyte being a lithium ion transfer medium, and a separator separating the cathode and the anode from each other. The lithium secondary battery generates and stores an electric energy through a change of chemical potentials when intercalation/deintercalation of lithium ions is performed at the cathode and the anode.

The lithium secondary battery has mainly been used in a portable electronic device, but recently, with the commercialization of an electric vehicle (EV) and a hybrid electric vehicle (HEV), the lithium secondary battery has also been used as an energy storage means of the electric vehicle and the hybrid electric vehicle.

Meanwhile, in order to increase a driving distance of the electric vehicle, researches to increase an energy density of the lithium secondary battery have been made, and the energy density of the lithium secondary battery can be increased through high capacity of the cathode.

The high capacity of the cathode may be achieved through Ni-rich that is a method for increasing Ni contents of Ni—Co—Mn based oxide forming a cathode active material, or may be achieved through voltage heightening of a cathode charging voltage.

However, since the Ni—Co—Mn based oxide in the Ni-rich state has a high interfacial reactivity and an unstable crystal structure, deterioration during cycle is accelerated, and thus it is difficult to secure a long-lifespan performance.

The foregoing is intended merely to aid in the understanding of the background of the present disclosure, and is not intended to mean that the present disclosure falls within the purview of the related art that is already known to those of ordinary skill in the art.

### SUMMARY

The present disclosure provides an electrolyte solution for a lithium secondary battery and a lithium secondary battery including the same, which can improve lifespan characteristics of the lithium secondary battery.

According to one form of the present disclosure, an electrolyte solution for a lithium secondary battery includes a lithium salt, a solvent, and a functional additive, wherein the functional additive contains a high-voltage additive, which may be a bis(2,2,2-trifluoroethyl) carbonate expressed by Formula 1 below:

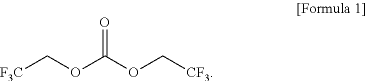 [SMILES: O=C(OCC(F)(F)F)OCC(F)(F)F]

An added amount of the high-voltage additive is equal to or smaller than 3.0 wt % based on an electrolyte weight.

It is preferable that the added amount of the high-voltage additive is 1.0 to 3.0 wt % based on the weight of the electrolyte solution.

The functional additive further contains an anode film additive being a vinylene carbonate (VC).

The anode film additive in an amount of 0.5 to 3.0 wt % is added based on the electrolyte weight.

The lithium salt is any one compound selected from the group consisting of LiPF₆, LiBF₄, LiClO₄, LiCl, LiBr, LiI, LiB₁₀Cl₁₀, LiCF₃SO₃, LiCF₃CO₂, LiASF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N(LiFSI), and (CF₃SO₂)₂NLi, or a mixture of two or more thereof.

The solvent is any one selected from the group consisting of a carbonate-based solvent, an ester-based solvent, an ether-based solvent, or a ketone-based solvent, or a mixture of two or more thereof.

Me according to another form of the present disclosure, a lithium secondary battery includes the above-described electrolyte solution, and it further includes a cathode including a cathode active material containing Ni, Co, and Mn; an anode including one or two or more anode active materials selected from carbon (C)-based or silicon (Si)-based materials; and a separator interposed between the cathode and the anode.

The cathode has a Ni content of 60 wt % or more.

According to the forms of the present disclosure, since oxidation stability of 4.6V or more is secured using the electrolyte solution containing the high-voltage additive and thus non-reactivity is suppressed at the high voltage, an effect of improving the long lifespan characteristics of the lithium secondary battery can be expected.

Further, output characteristics of the lithium secondary battery can be improved through reduction of a cell resistance.

Further, since the lifespan stability at the high temperature and high voltage is secured, the battery productivity can be improved.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIGS. 1 and 2 are graphs showing charging/discharging experiment results according to one form of the present disclosure and a comparative example; and

FIG. 3 is a photograph showing a cathode surface before and after charging/discharging operations according to one form of the present disclosure and a comparative example.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

An electrolyte solution for a lithium secondary battery according to one form of the present disclosure is a material forming an electrolyte being applied to the lithium secondary battery, and includes a lithium salt, a solvent, and a functional additive.

The lithium salt may be any one compound selected from the group consisting of LiPF₆, LiBF₄, LiClO₄, LiCl, LiBr, LiI, LiCF₃SO₃, LiCF₃CO₂, LiASF₆, LiSbF₆, CH₃SO₃Li, CF₃SO₃Li, LiN(SO₂C₂F₅)₂, Li(CF₃SO₂)₂N, LiC₄F₉SO₃, LiB(C₆H₅)₄, Li(SO₂F)₂N(LiFSI), and (CF₃SO₂)₂NLi, or a mixture of two or more thereof.

In this case, a total amount of the lithium salt may exist with a concentration of 0.1 to 1.2 M in the electrolyte solution.

Further, as the solvent, any one selected from the group consisting of a carbonate-based solvent, an ester-based solvent, an ether-based solvent, or a ketone-based solvent, or a mixture of two or more thereof may be used.

In this case, as the carbonate-based solvent, dimethyl carbonate (DMC), diethyl carbonate (DEC), dipropyl carbonate (DPC), methylpropyl carbonate (MPC), ethylpropyl carbonate (EPC), ethylmethyl carbonate (EMC), ethylene carbonate (EC), propylene carbonate (PC), butylene carbonate (BC), fluoroethylene carbonate (FEC), vinylene carbonate (VC), and the like may be used. Further, as the ester-based solvent, γ-butyrolactone (GBL), n-methyl acetate, n-ethyl acetate, n-propyl acetate, and the like may be used, and as the ether-based solvent, dibutyl ether and the like may be used, but are not limited thereto.

Also, the solvent may further include an aromatic hydrocarbon-based organic solvent. As detailed examples of the aromatic hydrocarbon-based organic solvent, benzene, fluorobenzene, bromobenzene, chlorobenzene, cyclohexylbenzene, isopropylbenzene, n-butylbenzene, octylbenzene, toluene, xylene, mesitylene, and the like may be used, and may be used alone or in combination thereof.

Meanwhile, as a functional additive being added to the electrolyte solution according to one form of the present disclosure, a high-voltage additive, which may be a bis(2,2,2-trifluoroethyl) carbonate (hereinafter, called “DFDEC”) expressed by Formula 1 below, may be used:

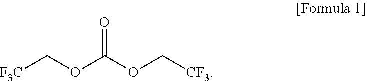 [SMILES: O=C(OCC(F)(F)F)OCC(F)(F)F]

In this case, the high-voltage additive being the bis(2,2,2-trifluoroethyl) carbonate (DFDEC) serves to improve oxidation stability of the electrolyte solution and to stabilize an interface between the cathode and the electrolyte solution at a high voltage, and the high-voltage additive is preferably added in an amount of 3.0 wt % or less based on the weight of the electrolyte solution, and more preferably, in an amount of 1.0 to 3.0 wt %.

If the added amount of the high-voltage additive is larger than 3.0 wt %, the cell resistance is increased due to forming of an excessive surface passivation layer, and thus the lifespan may be rather decreased. Further, if the added amount of the high-voltage additive is smaller than 1.0 wt %, the effect of oxidation stability improvement of the electrolyte solution may be incomplete, and it may be difficult to sufficiently form the surface passivation layer, so that the expected effect may be incomplete.

Meanwhile, as the functional additive, an anode film additive serving to form a film on the anode may be further added. For example, as the anode film additive, vinylene carbonate (VC) may be used.

In this case, it is preferable to add the anode film additive in the amount of 0.5 to 3.0 wt % based on the weight of the electrolyte solution. More preferably, the added amount of the anode film additive may be 1.5 to 2.5 wt %.

If the added amount of the anode film additive is smaller than 0.5 wt %, the long lifespan characteristics of the cell may be degraded, whereas if the added amount of the anode film additive is larger than 3.0 wt %, the cell resistance is increased due to the forming of the excessive surface passivation layer, and thus the battery output may be degraded.

Meanwhile, the lithium secondary battery according to one form of the present disclosure includes a cathode, an anode, and a separator in addition to the above-described electrolyte solution.

The cathode includes an NCM-based cathode active material containing Ni, Co, and Mn. Particularly, in the present form, it is preferable that the cathode active material included in the cathode consists of only the NCM-based cathode active material containing Ni in the amount of 60 wt % or more.

Further, the anode includes one or two or more anode active materials selected from carbon (C)-based or silicon (Si)-based materials.

As the carbon (C)-based anode active material, at least one material selected from the group consisting of artificial graphite, natural graphite, graphitized carbon fiber, graphitized mesocarbon microbead, fullerene, and amorphous carbon may be used.

Further, the silicon (Si)-based anode active material includes silicon oxide, silicon particles, and silicon alloy particles.

Meanwhile, the cathode and the anode are manufactured in a manner that electrode slurry is produced through mixing of a conductive material, a binder, and a solvent with the cathode/anode active materials, and then the electrode slurry is directly coated and dried on a current collector. In this case, as the current collector, aluminum (Al) may be used, but the current collector is not limited thereto. Since the electrode manufacturing method as described above is well known in the art to which the present disclosure pertains, detailed explanation thereof will be omitted in the description.

The binder serves to attach the respective active material particles well to each other or to attach them well to the current collector, and for example, as the binder, polyvinyl alcohol, carboxymethylcellulose, hydroxypropylcellulose, diacetylcellulose, polyvinyl chloride, carboxylated polyvinyl chloride, polyvinyl fluoride, polymer including ethylene oxide, polyvinyl pyrrolidone, polyurethane, polytetrafluoroethylene, polyvinylidene fluoride, polyethylene, polypropylene, styrene butadiene rubber, acrylated styrene butadiene rubber, epoxy resin, or nylon may be used, but the binder is not limited thereto.

Further, the conductive material is used to give conductivity to the electrode, and in the battery consisting thereof, any electronically conductive material can be used without causing the occurrence of a chemical change. For example, as the conductive material, natural graphite, artificial graphite, carbon black, acetylene black, Ketjen black, carbon fiber, metal powder of copper, nickel, aluminum, or silver, and metal fiber may be used, and further, any one of or a mixture of one or more of conductive materials, such as polyphenylene derivatives, may be used.

The separator inhibits a short between the cathode and the anode, and provides a movement path of lithium ions. As the separator, known materials, such as polyolefin-based polymer membranes, such as polypropylene, polyethylene, polyethylene/polypropylene, polyethylene/polypropylene/polyethylene, and polypropylene/polyethylene/polypropylene, or multilayers thereof, a microporous film, a woven fabric and a non-woven fabric, may be used. Further, a film obtained by coating a porous polyolefin film with a resin having an excellent stability may be used.

Hereinafter, the present disclosure will be described through various forms of the present disclosure and comparative examples.

### <Experiment 1> Experiment of Charging/Discharging Characteristics (Half Cell) at High Temperature (45° C.) According to the Kind of a Functional Additive and an Added Amount

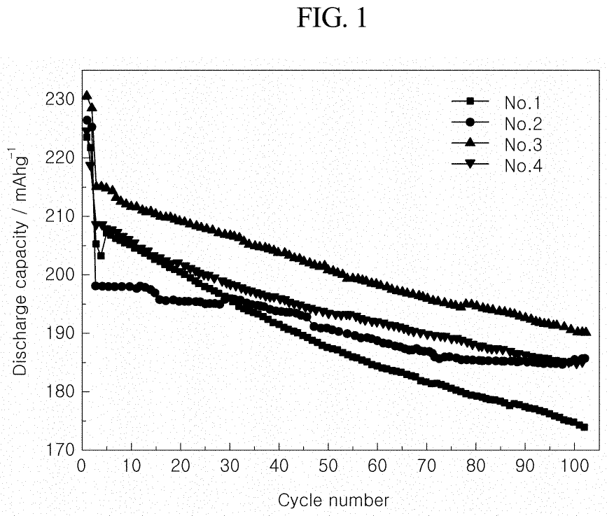

In order to find out the charging/discharging characteristics according to the kind of the functional additive added to the electrolyte solution on the half cell and the added amount thereof, the initial capacity and the capacity retention rate after 50 cycles were measured at high temperature (45° C.) while changing the kind and the added amount of the functional additive as shown in Table 1 below, and the measurement results are shown in Table 1 and FIG. 1.

In this case, the cycles were performed under 2.5-4.6V @ 0.1C 2Cyc+1C, 45° C., the lithium salt used to manufacture the electrolyte solution was 0.5M LiPF₆+0.5 LiFSI, and the solvent obtained by mixing ethylene carbonate (EC):ethylmethyl carbonate (EMC):dimethyl carbonate (DEC) in the volume ratio of 25:45:30 was used.

Further, NCM622 was used as the cathode, and carbon was used as the anode.

TABLE 1

| | | | | Initial | Capacity |
|---|---|---|---|---|---|
| | | | | Capacity | Retention |
| | | Additive | | @1C 1^{st}cyc | Rate @1C |
| Section | | VC | DFDEC | (mah/g) | 100 cyc (%) |
| No. 1 | Com. | 2.0 | — | 205 | 84.5 |
| | Example | | | | |
| No. 2 | Embodiment | 2.0 | 1.0 | 198 | 93.6 |
| No. 3 | Embodiment | 2.0 | 2.0 | 215 | 88.5 |
| No. 4 | Embodiment | 2.0 | 3.0 | 208 | 88.7 |

As can be confirmed in Table 1 and FIG. 1, the capacity retention rate was improved when the high-voltage additive according to the present disclosure was used together with the VC while changing the kind and the added amount of the high-voltage additive (Nos. 2 to 4) compared to the case of using only the VC as the general functional additive in the related art (No. 1).

Accordingly, in case of adding bis(2,2,2-trifluoroethyl) carbonate(DFDEC), being the high-voltage additive proposed in the present disclosure, to the electrolyte solution in the amount of 3.0 wt % or less, it was confirmed that the high-temperature lifespan improvement effect was able to be expected. In particular, in case of adding bis(2,2,2-trifluoroethyl) carbonate(DFDEC), as the high-voltage additive, to the electrolyte solution in the amount of 1.0 to 3.0 wt %, it was confirmed that the high-temperature lifespan was improved.

Meanwhile, in case of No. 2 in which the DFDEC in the amount of 1.0 wt % was added, the initial capacity was small when compared to No. 1, the comparative example, but the capacity retention rate was considerably high. Thus, it was confirmed that the capacity of No. 2 exhibits better capacity retention than No. 1 from 30 cyc or more.

### <Experiment 2> Experiment of Charging/Discharging Characteristics (Full Cell) at High Temperature (45° C.) According to the Kind of a Functional Additive

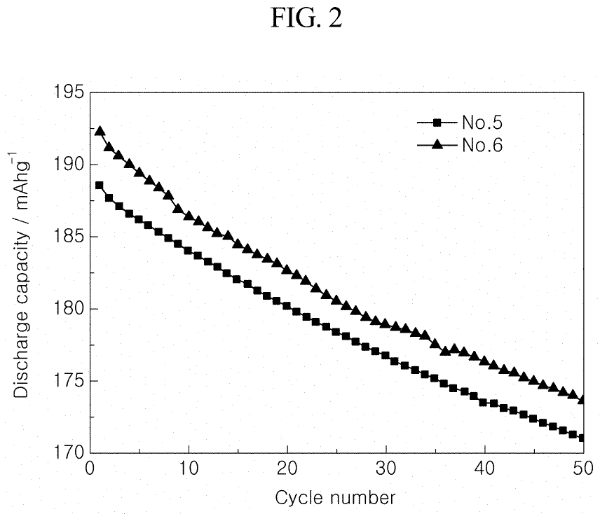

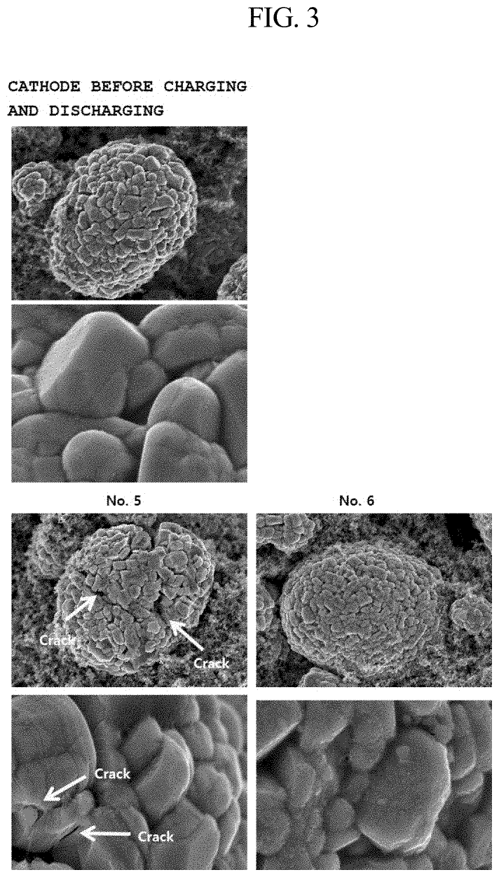

In order to find out the charging/discharging characteristics according to the kind of the functional additive added to the electrolyte solution on the full cell, the initial capacity and the capacity retention rate after 50 cycles were measured at high temperature (45° C.) while changing the kind of the functional additive as shown in Table 2 below, and the measurement results are shown in Table 2 and FIG. 2. Further, in order to find out the protection effect of the cathode surface according to the addition of the functional additive added to the electrolyte solution, the cathode surface after 50 cycles was observed, and the result is shown in FIG. 3.

In this case, the cycles were performed under 2.5-4.5V @ 1C, 45° C., the lithium salt used to manufacture the electrolyte solution was 0.5M LiPF₆+0.5 LiFSI, and the solvent obtained by mixing ethylene carbonate (EC):ethylmethyl carbonate (EMC):dimethyl carbonate (DEC) in the volume ratio of 25:45:30 was used.

Further, NCM622 was used as the cathode, and carbon was used as the anode. In this case, the coating ratio of the cathode was NCM622:Conductive agent:PVdF=86:7:7.

TABLE 2

| | | | | Initial | High-temp. |
|---|---|---|---|---|---|
| | | | | Capacity | lifespan |
| | | Additive | | @1C 1^{st}cyc | @1C 50 |
| Section | | VC | DFDEC | (mah/g) | cyc (%) |
| No. 5 | Com. | 2.0 | — | 188.5 | 90.3 |
| | Example | | | | |
| No. 6 | Embodiment | 2.0 | 2.0 | 192.2 | 90.7 |

As can be confirmed in Table 2 and FIG. 2, the initial capacity and the capacity retention rate were improved when the high-voltage additive according to the present disclosure was used together with the VC (No. 5) compared to the case of using only the VC as the general functional additive in the related art (No. 5).

Further, as can be confirmed in FIG. 3, in case of No. 5, it was confirmed that cracks were generated on the cathode surface after 50 cycles.

However, in case of No. 6, it was confirmed that no crack was generated even after 50 cycles and a uniform film was formed and maintained on the cathode surface.

Accordingly, it can be concluded that the uniform film serving as a passivation film was formed on the cathode surface due to the addition of the functional additive, and the uniform film was maintained even after 50 cycles to improve the capacity retention rate.

It was confirmed that the capacity retention rate was improved when the high-voltage additive according to the present disclosure was used together with the VC while changing the kind and the added amount of the high-voltage additive (Nos. 2 to 4) compared to the case of using only the VC being the general functional additive in the related art (No. 1).

Although specific forms of the present disclosure have been illustrated and described for illustrative purposes, those of ordinary skill in the art will appreciate that various modifications, additions and substitutions are possible, without departing from the scope and spirit of the present disclosure as disclosed in the accompanying claims.

What is claimed is:

1. An electrolyte solution for a lithium secondary battery, the electrolyte solution comprising:
a lithium salt;
a solvent; and
a functional additive containing a bis(2,2,2-trifluoroethyl) carbonate, expressed by Formula 1 below:

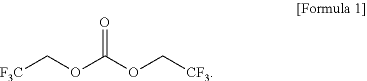 [SMILES: O=C(OCC(F)(F)F)OCC(F)(F)F]

2. The electrolyte solution according to claim 1, wherein an added amount of the bis(2,2,2-trifluoroethyl) carbonate is equal to or smaller than 3.0 wt % based on a weight of the electrolyte solution.

3. The electrolyte solution according to claim 2, wherein the added amount of the bis(2,2,2-trifluoroethyl) carbonate is 1.0 to 3.0 wt % based on the weight of the electrolyte solution.

4. The electrolyte solution according to claim 1, wherein the functional additive further contains a vinylene carbonate (VC).

5. The electrolyte solution according to claim 4, wherein the VC in an amount of 0.5 to 3.0 wt % is added based on the weight of the electrolyte solution.

6. The electrolyte solution according to claim 1, wherein the lithium salt is any one compound selected from the group consisting of LiPF₆, LiBF₄, LiClO₄, LiCl, LiBr, LiI, LiB₁₀Cl₁₀, LiCF₃SO₃, LiCF₃CO₂, LiAsF₆, LiSbF₆, LiAlCl₄, CH₃SO₃Li, CF₃SO₃Li, LiN(SO₂C₂F₅)₂, Li(CF₃SO₂)₂N, LiC₄F₉SO₃, LiB (C₆H₅)₄, Li(SO₂F)₂N(LiFSI) and (CF₃SO₂)₂NLi, or a mixture of two or more thereof.

7. The electrolyte solution according to claim 1, wherein the solvent is any one substance selected from the group consisting of a carbonate-based solvent, an ester-based solvent, an ether-based solvent, or a ketone-based solvent, or a mixture of two or more thereof.

8. A lithium secondary battery comprising an electrolyte solution including:
a lithium salt;
a solvent; and
a functional additive containing a bis(2,2,2-trifluoroethyl) carbonate, expressed by Formula 1 below:

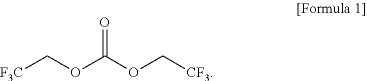 [SMILES: O=C(OCC(F)(F)F)OCC(F)(F)F]

9. The lithium secondary battery according to claim 8, further comprising:
a cathode including a cathode active material containing Ni, Co, and Mn;
an anode including one or two or more anode active materials selected from carbon (C)-based or silicon (Si)-based materials; and
a separator interposed between the cathode and the anode.

10. The lithium secondary battery according to claim 9, wherein the cathode has a Ni content of 60 wt % or more.
